(19) United States
(12) Patent Application Publication
(10) Pub. No.: US 2026/0044697 A1
(43) Pub. Date: Feb. 12, 2026

(54) Method for Decoding a Machine Readable Code

(71) Applicant: SICK AG, Waldkirch (DE)

(72) Inventor: Helmut WEBER, Emmendingen (DE)

(21) Appl. No.: 19/280,523

(22) Filed: Jul. 25, 2025

(30) Foreign Application Priority Data
Aug. 12, 2024 (EP) 24194164.0

(51) Int. Cl. G06K 7/14

(52) U.S. Cl. CPC G06K 7/146; G06K 7/1413; G06K 7/1417

(57) ABSTRACT

The invention relates to a method for decoding a machine readable code, comprising the machine generation of an input image of the machine readable code, wherein the input image has a plurality of image pixels having a respective value, wherein the sequence of the values of the image pixels defines an input signal development, wherein the input signal development comprises signal regions that each represent the signal energy in an associated signal region. The method comprises the transfer of the signal energy of at least one first signal region to a second signal region, wherein a result signal development is produced by transferring the signal energy. Finally, the method comprises the decoding of the machine readable code based on the result signal development.

The present invention relates to a method for decoding a code, for example a machine readable code, in which an input image of the machine readable code is machine generated, wherein the input image has a plurality of image pixels having a respective value, wherein the sequence of the values of the image pixels defines an input signal development, wherein the input signal development comprises signal regions that each represent the signal energy in an associated signal region.

The decoding of machine readable codes, such as barcodes or QR codes, is necessary in a variety of applications. These codes can consist of code modules that are white or black, for example. Conventionally, the code is in this respect acquired by a camera or a barcode scanner. The camera or the barcode scanner in this respect acquires a gray-scale image that is converted into a binary image to decode the machine readable code.

For this purpose, the gray-scale values are compared with a threshold value to then classify the different gray-scale values as either white or “1” or as black or “0”, whereby the binary image can be generated.

Due to blurring caused by imaging errors or movement, noise, brightness fluctuations, very small code modules and the like, regions in the gray-scale image can be incorrectly evaluated—in particular if signal regions of individual code modules are shifted towards the image pixel edges—which can lead to errors in the decoding of the machine readable code.

It is therefore the underlying object of the invention to provide a method that enables the decoding of a machine readable code.

This object is satisfied by a method according to claim 1.

The method according to the invention comprises the machine generation of an input image of the code, for example a machine readable code, wherein the input image has a plurality of image pixels having a respective value, wherein the sequence of the values of the image pixels defines an input signal development, wherein the input signal development comprises signal regions that each represent the signal energy, in particular of one of the image pixels, preferably of exactly one of the image pixels, in an associated signal region. The method according to the invention further comprises the transfer of the signal energy of at least one first signal region to a second signal region, wherein a result signal development is produced by transferring the signal energy. Finally, the method according to the invention comprises the decoding of the code, for example a machine readable code, based on the result signal development. The result signal development can e.g. be a result image, in particular a binary image.

According to the invention, the signal energy of a first signal region is therefore transferred into a second signal region. In general, the input signal development is changed by the transfer, for example by combining the signal energy of the first signal region and the signal energy of the second signal region. In particular, the signal energy of the first signal region is therefore added to the second signal region. For example, the signal energy of a signal region that is conventionally identified as black or 0 can be transferred to a signal region that is conventionally identified as white or 1. In this way, the signal energy contained in the first signal region is not lost when evaluating the machine readable code. The decoding of the machine readable code can be improved in this way, for example, in that the position of the code modules can be determined more precisely. It is understood that not only can the signal energy of a “black” signal region be transferred to a “white” signal region, but a transfer is also possible between two black signal regions or two white signal regions.

In particular, a result signal region with a constant height (over the result signal region) can be produced by the transfer. Due to the transfer, the circumstance can, for example, be considered that a code module of the machine readable code is mainly arranged in the region of an image pixel, but still extends in some areas into the region of an adjacent image pixel. The adjacent image pixel can, for example, map its signal energy into the first signal region. The first image pixel can map its signal energy into said second signal region so that the signal energy of the adjacent image pixel is then added to the first image pixel by the transfer. The signal region after the transfer, i.e. the signal region in the result signal development, can then in particular be wider and have a constant value over its width, whereby the code module is then mapped better in the result signal development and whereby a simplified and less error-prone decoding of the machine readable code results since the transferred signal region becomes independent of the image pixels.

As will be explained in more detail later, the machine generation of the input image of the machine readable code can take place using a camera, in particular an area camera or line camera, or a scanner. The input image has a plurality of image pixels having a respective value. The input image can in this respect be one-dimensional, i.e. comprising a single row of image pixels, or two-dimensional, i.e. comprising a two-dimensional array of image pixels. Each or at least a plurality of image pixels is preferably assigned a respective value, in particular a gray-scale value, that defines, for example, the brightness of the input image in the region of that image pixel. Each or a plurality of image pixels can also be assigned a plurality of values, for example in the case of a color image. The signal energy for the respective image pixel can in particular also be coded by the brightness. For example, the higher the brightness of the image pixel, the higher the signal energy. In particular, the brightness of an image pixel can be the higher, the more photons a sensor pixel assigned to the image pixel has captured.

An input signal development can be defined from the, for example one-dimensional or two-dimensional, sequence of the values of the image pixels and can accordingly also be one-dimensional or two-dimensional. The input signal development comprises signal regions that represent the respective signal energy, in particular of one of the image pixels. Thus, the input signal development preferably has the same height in a signal region in each case. The signal region in the input signal development in particular has a width that corresponds to the part of the input signal development that is assigned to the respective image pixel.

It should be noted that the height and the width of signals in the input signal development and the result signal development are mentioned herein. The input signal development and the result signal development are representations of signals. In this respect, the height refers to the respective value of the signal, i.e. the value on the Y axis or the ordinate. The height of the signal can, for example, be defined by the brightness of a respective image pixel. In this respect, the width in particular refers to the extent on the X axis or the abscissa. The width of a signal region can in this respect represent the width, in particular the metric width, of an image pixel and/or a sensor pixel. For two-dimensional signals, for example images, the area over which the signal has a height, in particular a constant height, can also be meant instead of the width. For simplification, only the width is often mentioned below, but an area is also meant in each case.

Preferably, the relative widths are used in each case herein since the absolute metric width of the signals ultimately does not have to be relevant. Instead, in particular the relative widths to one another are decisive.

The signal energy in a signal region in particular results as an area under the signal development.

A signal region is in particular a region of the input signal development and/or of the result signal development that has the same signal value or at least substantially the same signal value, i.e. the same height, throughout.

When transferring the signal energy of at least one first signal region to a second signal region, the area of the second signal region is therefore increased, whereby the added signal energy is represented. It is understood that, when transferring the signal energy, only a calculation is carried out, but no photons received from the machine readable codes are transferred, for example.

Furthermore, it is understood that the signal energy of a first signal region is transmitted to a second signal region by way of example herein. However, it is also possible for the signal energy of a plurality of (first) signal regions to be transferred to different (second) signal regions. The corresponding method step can then be repeated for this purpose.

By transferring the signal energy, the input signal development is changed so that the result signal development is produced. The decoding of the machine readable code preferably takes place based on the result signal development. For this purpose, the result signal development can, for example, be converted into a result image and/or a binary image or, mathematically speaking, into a vector/matrix.

In particular, that signal region which contains less signal energy can be regarded as the first signal region in each case. Accordingly, when combining two signal regions, that signal region with more signal energy is then the second signal region. Alternatively, it is also possible to regard that signal region with more signal energy as the first signal region. In this respect, a deduction can then be made from the higher-energy region to the lower-energy region.

Advantageous further developments of the invention can be found in the description, in the drawings and in the dependent claims.

According to a first advantageous embodiment, the signal energy transferred from the at least one first signal region to the second signal region is added to the second signal region and/or removed from the first signal region. All the signal energy is preferably transferred from the first signal region to the second signal region. After the transfer, the second signal region then contains more energy, the first signal region less, wherein the first signal region is preferably lowered to 0.

As will be described below, the width and/or position of the second signal region can change due to the transfer so that the second signal region then extends into the region in which the first signal region was originally arranged.

According to a further embodiment, the height of the input signal development in the second signal region is raised to a predetermined maximum value, wherein the signal energy represented by the second signal region preferably remains constant in this respect. The predetermined maximum value can, for example, be a 100% value or a “1”. The area under the second signal region, i.e. the signal energy, preferably remains the same, wherein the width of the second signal region is reduced while the height is increased. The height is in particular increased to the predetermined maximum value.

The raising of the height of the input signal development in the second signal region preferably takes place before the signal energy of the first signal region is transferred to the second signal region. Alternatively, it is also possible to raise the height of the second signal region to the predetermined maximum value after the transfer, whereby an adaptation of the result signal development then takes place. The area under the second signal region in the result signal development can likewise remain constant in this respect.

If the raising of the second signal region to the predetermined maximum value takes place in the input signal development (i.e. before the transfer), the signal of the second signal region, which has been raised to the maximum value and reduced in width, can be shifted so that it contacts and/or ends at the boundary between the original first signal region and the original second signal region, i.e. at the boundary between the first signal region and the second signal region from the input signal development. Such a shift is possible with both a one-dimensional input signal development and a two-dimensional input signal development.

According to a further embodiment, the signal energy of the at least one first signal region is converted into a transfer signal, preferably a constant transfer signal, with the height of the predetermined maximum value. If the second signal region likewise has a height with a value of the predetermined maximum value, the transfer signal can then be directly added to the second signal region raised in this way, and thus widens the second signal region. The conversion into the transfer signal can be an intermediate step in the transfer of the signal energy. The raised signal of a signal region can simultaneously also be regarded as a transfer signal. The widening of the signal region can in particular also be relative to the transfer signal, i.e. the widened second signal region created by the transfer, i.e. the result signal region, can in particular be wider than the transfer signal (of the second signal region).

Alternatively, it is also possible to convert the signal energy of the at least one first signal region into a transfer signal, preferably a constant transfer signal, with the height of the second signal region (i.e. without raising the height of the second signal region). This transfer signal can also completely comprise the signal energy of the at least one first signal region. The transfer signal designed in this way can then be added to the (original) second signal region. The thus arising second signal region of the result signal development may then possibly also be raised to the predetermined maximum value, as described above.

According to a further embodiment, the second signal region in the result signal development is widened by the transfer of the signal energy. The total width of the second signal region can be increased by the widening. The second signal region can therefore be wider than before, in particular wider than the second signal region in the input signal development.

According to a further embodiment, a transition between the second signal region of the result signal development and a further signal region of the result signal development lies within a signal region of the input signal development, i.e. in particular not at an edge or a boundary of a signal region. In particular due to the widening of the second signal region, an “edge”, i.e. one end of the second signal region, can lie within a pixel. In this way, a sub-pixel accuracy can be achieved, whereby a more accurate and more reliable decoding of the machine readable code becomes possible. It is understood that two transitions of signal regions can also lie within a single pixel, in particular if a “cropping” at both sides takes place.

According to a further embodiment, the input signal development defines values for a one-dimensional or two-dimensional region. The input signal development can, for example, originate from a line scan of a barcode and can accordingly define a one-dimensional region. Alternatively, the input signal development can originate from an area scan, in which e.g. a QR code was scanned, and can accordingly define and represent a two-dimensional region.

Instead of a machine readable code, it is also possible to apply the method to other codes (i.e. in principle any structures), for example, in OCR processes (Optical Character Recognition) or in measurement tasks in image analysis. In OCR processes, the transfer of signal energy can be used to make possibly blurred edges of letters clearer. The method (and the decoding apparatus mentioned later) can therefore be used for imaging any structures for whose further machine processing the discretization to image pixel size is not sufficient.

According to a further embodiment, the first signal region in the input signal development has at least two adjacent signal regions, wherein that adjacent signal region which has the smallest difference in signal energy from the first signal region is selected as the second signal region. For example, that adjacent signal region whose height differs the least from the first signal region is therefore selected as the second signal region. With such a procedure, it is then very likely that the signal in the first and second signal region originates from the same code module of the machine readable code and should therefore also be decoded together.

The selection of the second signal region based on the smallest difference in signal energy from the first signal region is possible for both one-dimensional and two-dimensional input signal developments. If, for example, square or rectangular sensor pixels and image pixels and thus rectangular or square signal regions are assumed in the case of two-dimensional machine readable codes, each signal region has eight adjacent signal regions, one of which can likewise be selected using the above-mentioned criterion.

Alternatively, for two-dimensional input signal developments, it is also possible to form a center of gravity based on the signal energy of the eight adjacent signal regions and the first signal region, wherein the center of gravity is therefore formed from nine signal regions. That adjacent signal region which is closest to the center of gravity can then be selected as the second signal region.

Alternatively or additionally, it is also possible to select the second signal region such that an equidistant distribution of the signal regions or of the assigned transfer signals is produced in the result signal development. This is in particular advantageous if the machine readable code has code elements of the same size in each case. The signal regions of the result signal development then precisely represent the code element of the code with a high degree of probability.

It is likewise possible to perform the transfer and the selection of the second signal region iteratively. This means that, in a first iteration step, the signal energy of a first signal region is transferred to a second signal region. In a second iteration step, the signal energy of at least one new first signal region can then be transferred to a new second signal region. The new first signal region and/or the new second signal region may have been produced in the first iteration step. More than two iteration steps can also be carried out according to the above-described pattern.

In general, it is understood that, for a plurality of signal regions or for all the signal regions in the input signal development, it is successively checked whether their signal energy is to be transferred to another signal region.

In the method described herein, regions in the signal development are therefore detected in which the correct assignment of black and white code modules is possible. Thus, the actual size of the code modules can be determined very precisely in these regions. Based on the determined size of the code modules, additional information is generated that can be used for more difficult regions, e.g. regions with small height changes in the signal or noisy regions, i.e. in particular for the first signal region, to enable a correct transfer of the signal energy.

It can preferably be known in the method that the size of the code modules is smaller than at least one of the image pixels (or smaller than the image pixels). This can e.g. be communicated to a decoding apparatus as a setting.

If the code modules are smaller and/or narrower than the image pixels, the maximum amplitude of an image pixel is only achieved if a plurality of identical (e.g. white) code modules are arranged directly adjacent such that an entire image pixel is completely covered. The next-lower (frequently) recurring amplitude level of local signal maxima in the input signal development is produced by a “direct hit” of a single white code module into an image pixel. Similarly, the next-higher (frequently) recurring amplitude level of local signal minima above the general minimum (as described in more detail below for the histogram) is produced by a direct hit of an e.g. black code module into a single image pixel. These amplitude levels directly indicate the size, i.e., for example, the width, of the code modules in relation to the pixel size. For example, with a local maximum of 80%, it can be concluded that a white code module has 80% of the size or width of an image pixel. In the same way, with a local maximum of 30%, it can be determined that a black code module has 70% (i.e. 100%-30%) of the size or width of an image pixel.

Accordingly, the method can comprise the step of determining the second-highest and/or second-lowest values of signal regions that occur multiple times in the input signal development, wherein the size and/or width of the code modules of the machine readable code is then inferred from the values. The size and/or width of the code modules can in particular be used (to produce equidistant signal regions in the result signal development) if it must be decided which signal region is to serve as the second signal region.

Preferably, value ranges can also first be recorded for the second-highest and/or second-lowest values of signal regions that occur multiple times in the input signal development. From the values in the value ranges, an average value formation or the like can then take place to determine the size and/or width of the code modules. In this way, the code module size can also be determined from noisy input images.

In further steps, a transfer of the signal energy can take place and the position of the individual code modules or of the associated signal regions can then also be determined, as described herein. As a result, it can be made possible to also decode machine readable codes whose code module widths are smaller than the size of the image pixels.

According to a further embodiment, the machine readable code comprises a barcode, in particular a target code, in particular for letters, and/or a two-dimensional code, for example a QR code or a DataMatrix code.

According to a further embodiment, the machine readable code comprises two different code modules, preferably only two different code modules. The code modules can, for example, be white and black regions. Accordingly, the machine readable code preferably comprises only white and black regions.

According to a further embodiment, a histogram is produced for the input image or a region in the input image that is selected for analysis and/or the input signal development, wherein the sequence of the values of the image pixels is changed by a normalization of the histogram. A pre-processing can therefore take place. The background of the pre-processing is that the gray-scale image that is usually recorded does not saturate in either the black or white region. Due to an inhomogeneous lighting, different image pixels can also appear brighter than other image pixels. For this reason, a normalization of the histogram can take place so that the values in the histogram are stretched over the entire width of the histogram. With a very high image inhomogeneity, a plurality of local histograms can alternatively or additionally be used to cover the sub-regions of the input signal development.

The following steps can in particular be carried out for the normalization of the histogram:
The input signal development is used, wherein the input signal development, for example, comprises a vector x for the image pixels and a vector y for the signal height;
A signal normalization can then be carried out, wherein the minimum of the signal height is searched for and this value is e.g. set to zero. Furthermore, the maximum of the signal height is searched for and this value is e.g. set to one. These values form the general maximum or minimum. All the values of the signal height between minimum and maximum in the histogram can then be normalized, in particular linearly.

The above two steps can preferably also be carried out for sub-regions of the input signal development, wherein in particular the vector x is divided into sub-regions, preferably according to a desired accuracy of the result signal development. In this respect, in particular for the vector y, each sub-region is assigned the respective signal height 28, whereby an input signal development with a higher resolution can be produced.

Furthermore, it is possible to reduce a noise in the input image by applying, for example, an averaging filter and/or a median filter.

According to a further embodiment, the machine generation of the input image takes place by means of a camera, wherein the camera has an optics and a plurality of sensor pixels, wherein the machine readable code is preferably illuminated by means of an illumination device during the generation of the input image. Radiation remitted by the machine readable code can be conducted through the optics and can subsequently impinge on the sensor pixels, wherein the amount of radiation impinging on a respective sensor pixel is mapped into a value of a corresponding image pixel of the input image. During the generation of the input image, the illumination device can irradiate the machine readable code to generate an input image with less noise and more contrast or to influence the signal strength such that shorter exposure times are created for the imaging in order, for example, to reduce the motion blur in the case of moving codes.

According to a further embodiment, the signals generated by the sensor pixels define the input image in that the signals generated by the sensor pixels each serve as a basis for the value of the associated image pixel. The signals generated by the sensor pixels can be processed to generate the value of the corresponding image pixel. The signal generated by the sensor pixels can also be adopted directly as the value of the corresponding image pixel. Likewise, the above-explained pre-processing, for example by normalizing the histogram, can be carried out on the signals generated by the sensor pixels.

A further subject of the invention is a decoding apparatus for decoding a machine readable code, comprising an acquisition unit and a computing device, wherein the acquisition unit is configured for the machine generation of an input image of the machine readable code, wherein the input image has a plurality of image pixels having a respective value, wherein the sequence of the values of the image pixels defines an input signal development, wherein the input signal development comprises signal regions that each represent the signal energy, in particular of one of the image pixels, preferably of a single one of the image pixels, in an associated signal region. The computing device is configured to transfer the signal energy of at least one first signal region to a second signal region, wherein a result signal development is produced by transferring the signal energy. The computing device is further configured to decode the machine readable code based on the result signal development, i.e., for example, based on a result image.

The decoding apparatus can in particular be configured to output a signal that includes the decoded code, i.e. the information included in the machine readable code, in particular in plain text.

The statements on the method according to the invention apply accordingly to the decoding apparatus according to the invention. This in particular applies with respect to advantages and preferred embodiments. It is furthermore understood that the features and embodiments mentioned herein can be combined with one another, unless explicitly stated otherwise.

The invention will be described purely by way of example with reference to the drawings in the following. There are shown:

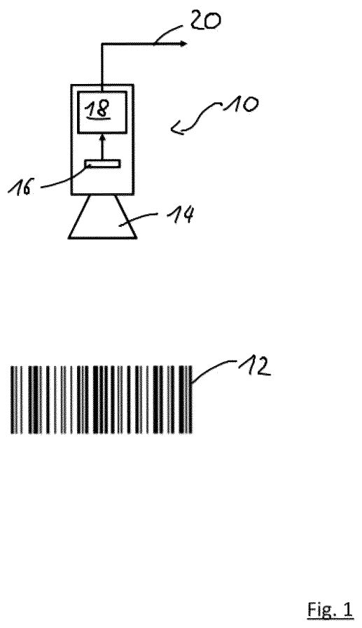

FIG. 1 a decoding apparatus and a machine readable code;

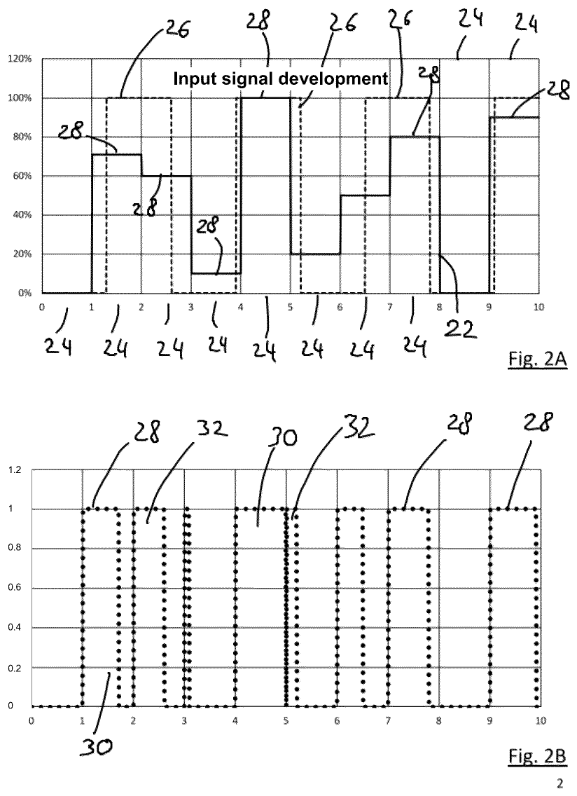

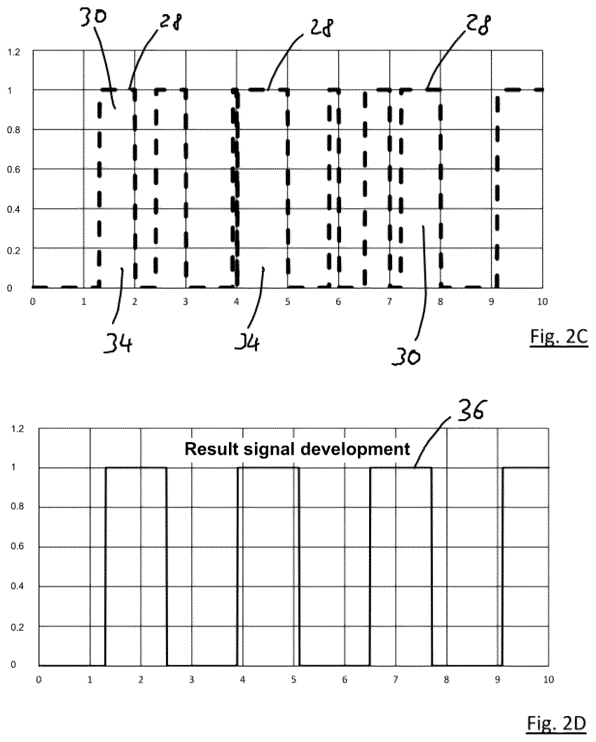

FIG. 2A-D diagrams with the input signal development, transfer signals and the result signal development;

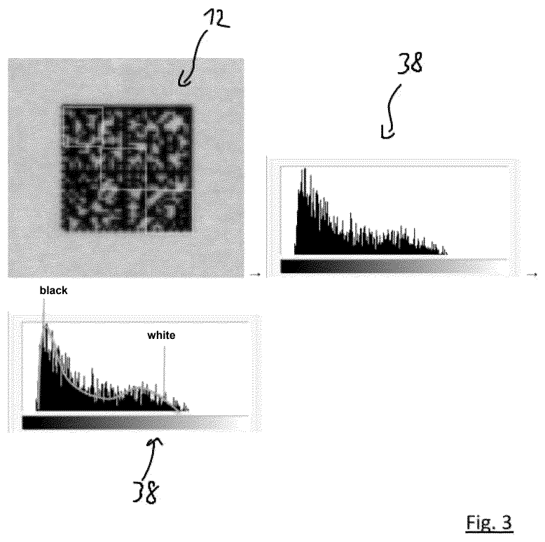

FIG. 3 an input image of a two-dimensional code and associated histograms.

FIG. 1 shows a decoding apparatus 10 that is directed to a machine readable code 12 in the form of a barcode. The barcode 12 is illuminated via an illumination device (not shown) of the decoding apparatus 10. Light emanating from the barcode 12 is conducted through an optics 14 to an acquisition unit 16 that comprises a plurality of sensor pixels. The acquisition unit generates an input image of the barcode 12 and transmits the input image to a computing device 18.

The computing device 18 performs the steps explained below to decode the barcode 12 and outputs a decoding result by means of a data interface 20. The decoding result can, for example, include the text contained in the barcode 12 or the sequence of numbers contained in the barcode 12 in plain text.

FIG. 2A shows an input signal development 22 that is plotted over ten image pixels 24. The image pixels are in this respect plotted on the X axis, wherein a first image pixel 24 is arranged in the range between 0 and 1 on the X axis, a second image pixel 24 in the range between 1 and 2 on the X axis, and a third image pixel in the range between 2 and 3 on the X axis. The remaining image pixels 24 are arranged accordingly. In the example explained here, the image pixels 24 correspond one-to-one to the sensor pixels (not shown).

In FIG. 2A, code modules 26 of the barcode 12 are furthermore shown as dashed lines. As can be seen, white and black code modules 26 of the same width alternate in the drawn region, wherein in each case only the white code modules 26 are provided with reference numerals. Only the white code modules 26 are also discussed in the following. A respective code module 26 has a width of approximately 1.3 image pixels.

The code module 26 that is located in the region of the second and third image pixel 24 covers 70% of the second image pixel 24 and 60% of the third image pixel 26. Accordingly, the (brightness) value of the second image pixel is 70% and the value of the third image pixel is 60%. Both values together result in 130% of an image pixel, which correlates to the above-mentioned width of the code module of 1.3 image pixels.

As a further example, the fifth image pixel 24 is completely superposed by a code module 26 so that the value assigned to the fifth image pixel 24 is 100%. In contrast, only 20% of the sixth image pixel 24 is superposed by a code module 26 so that the value assigned to the sixth image pixel 24 is only 20%. Together with the fourth image pixel 24 (10%), the correlation to the code module width of 1.3 image pixels (100%+20%+10%) also results here.

It can be seen that the input signal development 22 is constant in the region of an image pixel 24 in each case. Such a constant region is designated as the signal region 28.

In preparation for transferring the signal energy, for each signal region, the height of the input signal development is now raised to a predetermined maximum value that is “1” in the present example. This is shown in FIGS. 2B and 2C, wherein, in FIG. 2B, the raised signal development for each signal region is shifted to the left boundary of the respective image pixel 24, whereas, in FIG. 2C, a shift to the right boundary has taken place. FIGS. 2B and 2C accordingly show transfer signals.

It can be seen that the width of the signal regions is reduced so that the signal energy 30 represented by each signal region 28 (corresponding to the area under the signal region 28) remains the same.

It is then algorithmically determined for each signal region whether the respective signal region 28 is a first signal region 32 or a second signal region 34. In the case of adjacent signal regions 28, that signal region 28 with the lower signal energy 30 is determined as the first signal region 32 and the signal region 28 with the higher signal energy 30 is determined as the second signal region 34.

After determining the first and second signal region 32, 34, it is then algorithmically determined whether the signal region shifted to the right or to the left boundary should be taken over in a result signal development 36 (see FIG. 2B). The selection in this respect takes place such that the first and second signal region 32, 34 then directly adjoin one another. In the example shown here, the signal region 28 of the third image pixel 24 shifted to the left is used as the first signal region 32 and the signal region 28 of the second image pixel shifted to the right is used as the second signal region 34. Taken together, these two signal regions 32, 34 result in a region in the result signal development 36 that corresponds very precisely to the position and the course of the associated code module 26 from FIG. 2A.

Further, for example, the signal region 28 of the sixth image pixel 24 is used as the first signal region 32 (FIG. 2B). Since the fifth image pixel 24 has a value of 100%, the corresponding signal region 28 completely fills the region of the image pixel 24 so that there is no difference between the shift to the right and to the left. It is assumed purely by way of example that the signal region 28 shifted to the right in the region of the fifth image pixel 24 is used as the second signal region 34. Together with the narrow signal region of the fourth image pixel (FIG. 2C), these signal regions 28 taken together very accurately reflect the position and the width of the code module 26 in the region of the fifth image pixel 24, as shown in FIG. 2D. The signal region 28 in FIG. 2D is in this respect wider than the original signal region 28 in the region of the fifth image pixel 24. The signal region 28 created in this way also extends into the region of the original first signal region 32.

Before creating the input signal development 22, as shown in FIG. 2A, an average value filtering and/or a median filtering can take place, for example. Furthermore, a normalization using a histogram can take place. A two-dimensional machine readable code 12 is shown by way of example in FIG. 3. It can be seen that the machine readable code 12 appears blurred due to the lighting and the imaging accuracy. Accordingly, the histogram 38 shown there is also formed such that no saturation is achieved in the black and white regions. When normalizing the histogram, as explained above, the histogram can be stretched such that all the values between black and white then occur in the input signal development. The possibly noisy histogram courses can optionally be smoothed using averaging methods (e.g. median filter, moving average).

It can be seen that, by transferring the signal energy, the result signal development 36 in FIG. 2D corresponds much more precisely to the code modules 26 of the machine readable code 12 than the input signal development 22 from FIG. 2A. A much more accurate and reliable decoding of the machine readable code 12 can thus take place. This is possible even if the machine readable code 12 is arranged tilted, i.e. slanted.

### REFERENCE NUMERAL LIST

10 decoding apparatus
12 barcode
14 optics
16 acquisition unit
18 computing device
20 data interface
22 input signal development
24 image pixel
26 code module
28 signal region
30 signal energy
32 first signal region
34 second signal region
36 result signal development
38 histogram

1. A method for decoding a machine readable code, comprising
machine generating an input image of the machine readable code, wherein the input image has a plurality of image pixels having a respective value, wherein the sequence of the values of the image pixels defines an input signal development, wherein the input signal development comprises signal regions that each represent the signal energy in an associated signal region,
transferring the signal energy of at least one first signal region to a second signal region, wherein a result signal development is produced by transferring the signal energy,
decoding the machine readable code based on the result signal development.

2. The method according to claim 1,
wherein the signal energy transferred from the at least one first signal region to the second signal region is added to the second signal region and/or removed from the first signal region.

3. The method according to claim 1,
wherein the height of the input signal development in the second signal region is raised to a predetermined maximum value.

4. The method according to claim 3,
wherein the signal energy represented by the second signal region remains constant.

5. The method according to claim 3,
wherein the signal energy of the at least one first signal region is converted into a transfer signal with the height of the predetermined maximum value.

6. The method according to claim 1,
wherein the second signal region in the result signal development is widened by the transfer of the signal energy.

7. The method according to claim 1,
wherein a transition between the second signal region of the result signal development and a further signal region of the result signal development lies within a signal region of the input signal development.

8. The method according to claim 1,
wherein the input signal development defines values for a one-dimensional or two-dimensional region.

9. The method according to claim 1,
wherein the first signal region in the input signal development has at least two adjacent signal regions, wherein that adjacent signal region which has the smallest difference in signal energy from the first signal region is selected as the second signal region.

10. The method according to claim 1,
wherein the machine readable code comprises a barcode and/or a two-dimensional code

11. The method according to claim 10,
wherein the barcode is a target code.

12. The method according to claim 10,
wherein the two-dimensional code is one of a QR code and a DataMatrix code.

13. The method according to claim 1,
wherein the machine readable code comprises two different code modules.

14. The method according to claim 13,
wherein the machine readable code comprises only two different code modules.

15. The method according to claim 1,
wherein a histogram is produced for the input image and/or the input signal development, wherein the sequence of the values of the image pixels is changed by a normalization of the histogram.

16. The method according to claim 1,
wherein the machine generation of the input image takes place by means of a camera that has an optics and a plurality of sensor pixels.

17. The method according to claim 16,
wherein the machine readable code is illuminated by means of an illumination device during the generation of the input image.

18. The method according to claim 16,
wherein the signals generated by the sensor pixels define the input image in that the signals generated by the sensor pixels each serve as a basis for the value of the associated image pixel.

19. A decoding apparatus for decoding a machine readable code,
comprising an acquisition unit and a computing device, wherein the acquisition unit is configured for the machine generation of an input image of the machine readable code, wherein the input image has a plurality of image pixels having a respective value, wherein the sequence of the values of the image pixels defines an input signal development, wherein the input signal development comprises signal regions that each represent the signal energy in an associated signal region,
wherein the computing device is configured
to transfer the signal energy of at least one first signal region to a second signal region, wherein a result signal development is produced by transferring the signal energy,
to decode the machine readable code based on the result signal development.
